(19) United States
(12) Patent Application Publication
(10) Pub. No.: US 2012/0244352 A1
(43) Pub. Date: Sep. 27, 2012

(54) PROCESS FOR PRODUCING POLYIMIDE FILM, AND POLYIMIDE FILM

(75) Inventors: Nobuharu Hisano, Ube-shi (JP); Shin-ichiro Kohama, Ube-shi (JP); Taizou Murakami, Ube-shi (JP); Hiroaki Yamaguchi, Ube-shi (JP)

(73) Assignee: UBE INDUSTRIES, LTD., Ube-shi (JP)

(21) Appl. No.: 13/514,756

(22) PCT Filed: Dec. 8, 2010
(86) PCT No.: PCT/JP2010/072049

§ 371 Date: Jun. 8, 2012

(30) Foreign Application Priority Data
Dec. 9, 2009 (JP) 2009-279413

(51) Int. Cl. C08G 73/10; B32B 37/24; B29C 39/00; B32B 15/08; C09J 7/02

(52) U.S. Cl. 428/355 N; 428/458; 264/234; 156/242; 528/353

(57) ABSTRACT

A polyimide film having improved adhesiveness is produced by
flow-casting a solution of a polyamic acid, which is prepared by reacting a tetracarboxylic acid component and a diamine component, on a support, and drying the solution to form a self-supporting film;
applying a solution containing a surface treatment agent to one side or both sides of the self-supporting film, wherein the solvent of the surface treatment agent solution is a water-soluble liquid and has a surface tension of 32 mN/m or less at 20° C. and a boiling point of 125° C. or higher; and
heating the self-supporting film to provide a polyimide film.

### TECHNICAL FIELD

The present invention relates to a process for producing a polyimide film having improved adhesiveness, and the polyimide film. The present invention also relates to a polyimide laminate which is prepared by laminating an adhesive layer and/or a metal layer on the polyimide film.

### BACKGROUND ART

A polyimide film has been widely used in various applications such as the electric/electronic device field and the semiconductor field, because it has excellent heat resistance, chemical resistance, mechanical strength, electric properties, dimensional stability and so on. For example, a copper-clad laminate wherein a copper foil is laminated on one side or both sides of a polyimide film is used for a flexible printed circuit board (FPC).

In general, however, a polyimide film may not have adequate adhesiveness. When a metal foil such as a copper foil is bonded onto a polyimide film via a heat-resistant adhesive such as an epoxy resin adhesive, the obtained laminate may not have adequately high adhesive strength. In addition, a laminate having adequately high peel strength may not be obtained when a metal layer is formed on a polyimide film by a dry plating method such as metal vapor deposition and sputtering, or when a metal layer is formed on a polyimide film by a wet plating method such as electroless plating.

Patent document 1 discloses a process for producing a polyimide film, which allows improvements in adhesiveness of the obtained polyimide film, comprising steps of:

applying a surface treatment solution containing a heat-resistant surface treatment agent (coupling agent) to a surface of a solidified film of a polyamic acid; and then

heating the solidified film, to which the surface treatment solution is applied, at a temperature of from 100° C. to 600° C. to dry and heat-treat the solidified film and imidize the polyamic acid contained in the film.

### CITATION LIST

### Patent Document

Patent document 1; JP-A-S62-267330

### SUMMARY OF INVENTION

### Problems to be Solved by the Invention

When a solution containing a heat-resistant surface treatment agent (coupling agent) is applied to a surface of a solidified film of a polyamic acid as described in Patent document 1, the adhesiveness of the obtained polyimide film may be improved, and yet the adhesiveness may be reduced during storage under high temperature conditions or under high temperature and high humidity conditions. The peel strength may be reduced, for example, when a polyimide-metal laminate is subjected to treatment at 150° C. for a longer time, or treatment at 121° C. and 100% RH for a longer time.

Meanwhile, with the reduction in size, thickness and weight of electronic devices in recent years, there is a need for the reduction in size of the inner parts. Thus, there is a need for a further thinner copper-clad polyimide film, which is used for a flexible printed circuit board (FPC) and the like. Therefore, a thinner polyimide film, specifically a polyimide film having a thickness of 20 μm or less, further 15 μm or less, further 10 μm or less has begun to be used. In the case of such a thin polyimide film, however, when a solution containing a heat-resistant surface treatment agent is applied to a surface of a solidified film of a polyamic acid, a crack is apt to occur in the solidified film. If a crack does not occur, the applied solution may be repelled, and therefore a polyimide film having an even surface may not be obtained.

An objective of the present invention is to provide a process for producing a polyimide film having excellent adhesiveness after heat treatment or after high temperature/high humidity treatment, as well as excellent initial adhesiveness. Another objective of the present invention is to provide a process for producing a thin polyimide film having excellent adhesiveness, which has an even surface and a thickness of 20 μm or less, further 15 μm or less, further 10 μm or less, while preventing cracks in a solidified film of a polyamic acid. Furthermore, an objective of the present invention is to provide a polyimide laminate having adequately high peel strength, which comprises a polyimide film produced by the process, and an adhesive layer or a metal layer.

### Means for Solving the Problems

The present invention relates to the following items.

[1] A process for producing a polyimide film, comprising steps of:

flow-casting a solution of a polyamic acid, which is prepared by reacting a tetracarboxylic acid component and a diamine component, on a support, and drying the solution to form a self-supporting film;

applying a solution containing a surface treatment agent to one side or both sides of the self-supporting film; and

heating the self-supporting film, to which the surface treatment agent solution is applied, to provide a polyimide film;

wherein the surface treatment agent solution contains a solvent which is a water-soluble liquid and has a surface tension of 32 mN/m or less at 20° C. and a boiling point of 125° C. or higher.

[2] A process for producing a polyimide film as described in [1], wherein the solvent of the surface treatment agent solution contains at least one selected from the group consisting of ethylene glycol monoethyl ether, ethylene glycol monobutyl ether, diethylene glycol monoethyl ether acetate and diacetone alcohol.

[3] A process for producing a polyimide film as described in any one of [1] to [2], wherein the tetracarboxylic acid component comprises 3,3′,4,4′-biphenyltetracarboxylic dianhydride and/or pyromellitic dianhydride as the main component; and the diamine component comprises p-phenylenediamine and/or diaminodiphenyl ether as the main component.

[4] A process for producing a polyimide film as described in any one of [1] to [3], wherein the surface treatment agent is a silane coupling agent.

[5] A process for producing a polyimide film as described in any one of [1] to [4], wherein the polyimide film is produced by thermal imidization.

[6] A process for producing a polyimide film as described in any one of [1] to [5], wherein the self-supporting film has a weight loss on heating of from 20 wt % to 50 wt %.

[7] A process for producing a polyimide film as described in any one of [1] to [6], wherein the polyimide film produced is to be used for the lamination to a metal layer or an adhesive layer.

[8] A process for producing a polyimide film as described in any one of [1] to [7], wherein the polyimide film produced has a thickness of 20 μm or less.

[9] A polyimide film produced by a process for producing a polyimide film as described in any one of [1] to [8].

[10] A polyimide-metal laminate comprising a polyimide film as described in [9], and a metal layer which is formed on the surface of the polyimide film to which the surface treatment agent solution is applied during production.

[11] A polyimide-metal laminate as described in [10], wherein the metal layer is formed by a metallizing method or a wet plating method.

[12] A polyimide laminate comprising a polyimide film as described in [9], and an adhesive layer which is formed on the surface of the polyimide film to which the surface treatment agent solution is applied during production.

[13] A polyimide-metal laminate comprising a polyimide laminate as described in [12], and a metal foil which is bonded onto the adhesive layer of the polyimide laminate.

### Effect of the Invention

According to the present invention, in order to improve the adhesiveness of the polyimide film, a solution containing a surface treatment agent such as a coupling agent is applied to a surface of a solidified film (hereinafter, also referred to as “self-supporting film”) of a polyamic acid, and then the film is heated to effect imidization. The solvent of the surface treatment agent solution (hereinafter, also referred to as “application solvent”) used in the present invention is a water-soluble liquid and has a surface tension of 32 mN/m or less at 20° C. and a boiling point of 125° C. or higher. When using such a solvent, a polyimide film having excellent adhesiveness, in which the adhesiveness is less reduced under high temperature conditions or under high temperature and high humidity conditions, may be obtained.

In addition, when using such a solvent, a solution containing a surface treatment agent may be more evenly applied to a surface of a thin solidified film of a polyamic acid having a thickness of, for example, 20 μm or less, further 15 μm or less, further 10 μm or less, while preventing the repelling of the solution and the occurrence of cracks. Therefore, according to the present invention, there may be provided a thin polyimide film having excellent adhesiveness, which has an even surface and a thickness of 20 μm or less, further 15 μm or less, further 10 μm or less. In other words, the present invention may be applied to a thin polyimide film, and therefore a laminate may be obtained substantially without limitation of thickness.

Moreover, the excellent fire-safety may be achieved, in the application of the present invention to a mass production of film.

### DESCRIPTION OF EMBODIMENTS

The polyimide film of the present invention may be produced by

flow-casting a solution of a polyamic acid, which is prepared by reacting a tetracarboxylic acid component and a diamine component in an organic solvent, on a support,

heating and drying the solution to form a self-supporting film;

applying a solution containing a surface treatment agent to one side or both sides of the self-supporting film;

heating the self-supporting film mainly to remove the application solvent from the film, as necessary; and then

heating the self-supporting film to effect imidization.

The surface treatment agent solution to be used in the present invention is a solution (including a suspension) in which a surface treatment agent is dissolved or homogeneously suspended in a solvent, which is a water-soluble liquid and has a surface tension of 32 mN/m or less at 20° C. and a boiling point of 125° C. or higher.

The polyimide film of the present invention may be produced by thermal imidization and/or chemical imidization. When the tetracarboxylic acid component and/or the diamine component comprises a plurality of compounds, these components may be polymerized by random-copolymerization or block-copolymerization, or a combination of random-copolymerization and block-copolymerization.

Examples of the process for producing the polyimide film of the present invention include

(1) a process comprising steps of:

flow-casting a polyamic acid solution, or a polyamic acid solution composition which is prepared by adding, as necessary, an imidization catalyst, a dehydrating agent, a parting agent, an inorganic fine particle and the like to a polyamic acid solution, on a support to form a film;

heating and drying the solution or the composition to form a self-supporting film;

applying a solution containing a surface treatment agent to one side or both sides of the self-supporting film; and then

thermally dehydrative cyclizing the polyamic acid and removing the solvent to provide a polyimide film;

and
(2) a process comprising steps of:

flow-casting a polyamic acid solution composition which is prepared by adding a cyclization catalyst and a dehydrating agent, and, as necessary, an inorganic fine particle and the like to a polyamic acid solution, on a support to form a film;

chemically dehydrative cyclizing the polyamic acid and, as necessary, heating and drying the composition to form a self-supporting film;

applying a solution containing a surface treatment agent to one side or both sides of the self-supporting film; and then

heating the self-supporting film for removing the solvent and imidizing to provide a polyimide film.

Specific examples of the tetracarboxylic dianhydride include 3,3′,4,4′-biphenyltetracarboxylic dianhydride (s-BPDA) and pyromellitic dianhydride (PMDA). Other examples of the tetracarboxylic dianhydride include 2,3,3′,4′-biphenyltetracarboxylic dianhydride (a-BPDA), oxydiphthalic dianhydride, diphenyl sulfone-3,4,3′,4′-tetracarboxylic dianhydride, bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenone tetracarboxylic dianhydride, 3,3′,4,4′-benzophenone tetracarboxylic dianhydride, bis(3,4-dicarboxyphenyl)methane dianhydride, 2,2-bis(3,4-dicarboxyphenyl)propane dianhydride, p-phenylene bis(trimellitic acid monoester anhydride), p-biphenylene bis(trimellitic acid monoester anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride, 2,3,6,7-naphthalene tetracarboxylic dianhydride, 1,4,5,8-naphthalene tetracarboxylic dianhydride, and 4,4′-(2,2-hexafluoroisopropylidene)diphthalic dianhydride. These may be used alone or in combination of two or more. A tetracarboxylic dianhydride used in the present invention may be appropriately selected depending on the desired properties, and the like.

The tetracarboxylic acid component may preferably comprise s-BPDA and/or PMDA as the main component. For example, the tetracarboxylic acid component may preferably comprise at least one acid component selected from the group consisting of s-BPDA and PMDA, preferably at least one of s-BPDA and PMDA, particularly preferably s-BPDA, in an amount of 50 mol % or more, more preferably 70 mol % or more, particularly preferably 75 mol % or more, based on the total molar quantity of the acid component, because the polyimide film obtained may have excellent mechanical properties and other properties.

Specific examples of the diamine include

1) diamines having one benzene ring such as p-phenylenediamine (1,4-diaminobenzene; PPD), 1,3-diaminobenzene, 2,4-toluenediamine, 2,5-toluenediamine, and 2,6-toluenediamine;

2) diamines having two benzene rings such as diaminodiphenyl ethers, including 4,4′-diaminodiphenyl ether, 3,3′-diaminodiphenyl ether and 3,4′-diaminodiphenyl ether, 4,4′-diaminodiphenylmethane, 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl)sulfide, 4,4′-diaminobenzanilide, 3,3′-dichlorobenzidine, 3,3′-dimethylbenzidine, 2,2′-dimethylbenzidine, 3,3′-dimethoxybenzidine, 2,2′-dimethoxybenzidine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfone, 3,4′-diaminodiphenyl sulfone, 4,4′-diaminodiphenyl sulfone, 3,3′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenyl sulfoxide, 3,4′-diaminodiphenyl sulfoxide, and 4,4′-diaminodiphenyl sulfoxide;

3) diamines having three benzene rings such as 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene, 1,4-bis(3-aminophenoxy)benzene, 1,4-bis(4-aminophenoxy)benzene, 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenyl sulfide)benzene, 1,3-bis(4-aminophenyl sulfide)benzene, 1,4-bis(4-aminophenyl sulfide)benzene, 1,3-bis(3-aminophenyl sulfone)benzene, 1,3-bis(4-aminophenyl sulfone)benzene, 1,4-bis(4-aminophenyl sulfone)benzene, 1,3-bis[2-(4-aminophenyl)isopropyl]benzene, 1,4-bis[2-(3-aminophenyl)isopropyl]benzene, and 1,4-bis[2-(4-aminophenyl)isopropyl]benzene; and

4) diamines having four benzene rings such as 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl] ketone, bis[3-(4-aminophenoxy)phenyl] ketone, bis[4-(3-aminophenoxy)phenyl] ketone, bis[4-(4-aminophenoxy)phenyl] ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane, 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, and 2,2-bis[4-(4-aminophenoxy)phenyl]-1,1,1,3,3,3-hexafluoropropane. These may be used alone or in combination of two or more. A diamine used in the present invention may be appropriately selected depending on the desired properties, and the like.

The diamine component may preferably comprise PPD and/or diaminodiphenyl ether as the main component. For example, the diamine component may preferably comprise at least one diamine component selected from the group consisting of PPD and diaminodiphenyl ethers, preferably at least one of PPD, 4,4′-diaminodiphenyl ether and 3,4′-diaminodiphenyl ether, particularly preferably PPD, in an amount of 50 mol % or more, more preferably 70 mol % or more, particularly preferably 75 mol % or more, based on the total molar quantity of the diamine component, because the polyimide film obtained may have excellent mechanical properties and other properties.

Among others, preferred is a polyimide prepared from s-BPDA, and PPD or, alternatively, PPD and diaminodiphenyl ether such as 4,4′-diaminodiphenyl ether and 3,4′-diaminodiphenyl ether. In this case, a ratio of PPD/diaminodiphenyl ether (molar ratio) may be preferably 100/0 to 85/15.

Also, preferred is a polyimide prepared from PMDA, or a combination of s-BPDA and PMDA as an aromatic tetracarboxylic dianhydride and an aromatic diamine such as PPD, tolidine (ortho- and meta-types) and diaminodiphenyl ether such as 4,4′-diaminodiphenyl ether and 3,4′-diaminodiphenyl ether. The aromatic diamine may be preferably PPD, or an aromatic diamine in which a ratio of PPD/diaminodiphenyl ether is 90/10 to 10/90. In this case, a ratio of s-BPDA/PMDA may be preferably 0/100 to 90/10.

In addition, preferred is a polyimide prepared from PMDA, and PPD and diaminodiphenyl ether such as 4,4′-diaminodiphenyl ether and 3,4′-diaminodiphenyl ether. In this case, a ratio of diaminodiphenyl ether/PPD may be preferably 90/10 to 10/90.

A polyamic acid, which is a polyimide precursor, may be prepared by reacting the above-mentioned tetracarboxylic acid component and the above-mentioned diamine component by any known method. A solution of a polyamic acid (which may be partially imidized, so long as the solution remains a homogeneous solution) may be prepared, for example, by reacting substantially equimolar amounts of a tetracarboxylic acid component and a diamine component in an organic solvent. Alternatively, two or more polyamic acids in which either of these two components is excessive may be prepared, and subsequently, these polyamic acid solutions may be combined and then mixed under reaction conditions. The polyamic acid solution thus obtained may be used without any treatment, or alternatively, after removing or adding a solvent, if necessary, for the preparation of a self-supporting film.

Any known solvent may be used as the organic solvent of the polyamic acid solution. Examples of the organic solvent of the polyamic acid solution include N-methyl-2-pyrrolidone, N,N-dimethylformamide, N,N-dimethylacetamide and N,N-diethylacetamide. These organic solvents may be used alone or in combination of two or more.

In the case of thermal imidization, the polyamic acid solution may contain an imidization catalyst, an organic phosphorous-containing compound, an inorganic fine particle, and the like, as necessary.

In the case of chemical imidization, the polyamic acid solution may contain a cyclization catalyst and a dehydrating agent, and an inorganic fine particle, and the like, as necessary.

Examples of the imidization catalyst include substituted or unsubstituted nitrogen-containing heterocyclic compounds, N-oxide compounds of the nitrogen-containing heterocyclic compounds, substituted or unsubstituted amino acid compounds, aromatic hydrocarbon compounds and aromatic heterocyclic compounds having a hydroxyl group. Particularly preferable examples of the imidization catalyst include lower-alkyl imidazoles such as 1,2-dimethylimidazole, N-methylimidazole, N-benzyl-2-methylimidazole, 2-methylimidazole, 2-ethyl-4-methylimidazole and 5-methylbenzimidazole; benzimidazoles such as N-benzyl-2-methylimidazole; and substituted pyridines such as isoquinoline, 3,5-dimethylpyridine, 3,4-dimethylpyridine, 2,5-dimethylpyridine, 2,4-dimethylpyridine and 4-n-propylpyridine. The amount of the imidization catalyst to be used is preferably about 0.01 to 2 equivalents, particularly preferably about 0.02 to 1 equivalents relative to the amide acid unit in the polyamide acid. When an imidization catalyst is used, the polyimide film obtained may have improved properties, particularly extension and edge-cracking resistance.

Examples of the organic phosphorous-containing compound include phosphates such as monocaproyl phosphate, monooctyl phosphate, monolauryl phosphate, monomyristyl phosphate, monocetyl phosphate, monostearyl phosphate, triethyleneglycol monotridecyl ether monophosphate, tetraethyleneglycol monolauryl ether monophosphate, diethyleneglycol monostearyl ether monophosphate, dicaproyl phosphate, dioctyl phosphate, dicapryl phosphate, dilauryl phosphate, dimyristyl phosphate, dicetyl phosphate, distearyl phosphate, tetraethyleneglycol mononeopentyl ether diphosphate, triethylene glycol monotridecyl ether diphosphate, tetraethyleneglycol monolauryl ether diphosphate, and diethyleneglycol monostearyl ether diphosphate; and amine salts of these phosphates. Examples of the amine include ammonia, monomethylamine, monoethylamine, monopropylamine, monobutylamine, dimethylamine, diethylamine, dipropylamine, dibutylamine, trimethylamine, triethylamine, tripropylamine, tributylamine, monoethanolamine, diethanolamine and triethanolamine.

Examples of the cyclization catalyst include aliphatic tertiary amines such as trimethylamine and triethylenediamine, aromatic tertiary amines such as dimethylaniline, and heterocyclic tertiary amines such as isoquinoline, pyridine, α-picoline and β-picoline.

Examples of the dehydrating agent include aliphatic carboxylic anhydrides such as acetic anhydride, propionic anhydride and butyric anhydride, and aromatic carboxylic anhydrides such as benzoic anhydride.

Examples of the inorganic fine particle include particulate inorganic oxide powders such as titanium dioxide powder, silicon dioxide (silica) powder, magnesium oxide powder, aluminum oxide (alumina) powder and zinc oxide powder; particulate inorganic nitride powders such as silicon nitride powder and titanium nitride powder; inorganic carbide powders such as silicon carbide powder; and particulate inorganic salt powders such as calcium carbonate powder, calcium sulfate powder and barium sulfate powder. These inorganic fine particles may be used in combination of two or more. These inorganic fine particles may be homogeneously dispersed using the known means.

A self-supporting film of a polyamic acid solution may be prepared by flow-casting the polyamic acid solution or the polyamic acid solution composition on a support; and then heating the solution or the composition to the extent that a self-supporting film is formed (which means a stage before a common curing process), for example, to the extent that the film may be peeled from the support.

There are no particular restrictions to the solid content of the polyamic acid solution to be used in the present invention, so long as the polyamic acid solution has a viscosity suitable for the production of a self-supporting film. In general, the solid content of the polyamic acid solution may be preferably within a range of from 10 wt % to 30 wt %, more preferably from 15 wt % to 27 wt %, further preferably from 18 wt % to 26 wt %.

In the preparation of a self-supporting film, the heating temperature and the heating time may be appropriately determined. In the case of thermal imidization, a polyamic acid solution may be heated at a temperature of from 100° C. to 180° C. for about 1 min to 60 min, for example.

There are no particular restrictions to the support, so long as a polyamic acid solution may be cast on the substrate. A substrate having a smooth surface may be suitably used. A metallic drum or belt such as a stainless drum or belt, for example, may be used as the support.

There are no particular restrictions to the self-supporting film, so long as the solvent is removed from the film and/or the film is imidized to the extent that the film may be peeled from the support. In the case of thermal imidization, it is preferred that a weight loss on heating of a self-supporting film is within a range of 20 wt % to 50 wt %, and it is further preferred that a weight loss on heating of a self-supporting film is within a range of 20 wt % to 50 wt % and an imidization rate of a self-supporting film is within a range of 7% to 55%. When a self-supporting film has a weight loss on heating and an imidization rate within the above-mentioned ranges, the self-supporting film may have sufficient mechanical properties, and a surface treatment agent solution may be more evenly and more easily applied onto the surface of the self-supporting film and no foaming, flaws, crazes, cracks and fissures are observed in the polyimide film obtained after imidizing.

The weight loss on heating of a self-supporting film may be calculated by the following formula from the weight of the self-supporting film (W1) and the weight of the film after curing (W2).

Weight loss on heating (wt %)={(W1−W2)/W1}×100

The imidization rate of a self-supporting film may be calculated based on the ratio of the vibration band peak area or height in the IR spectra of a self-supporting film and the fully-cured film thereof (polyimide film), which were measured according to ATR method.

According to the present invention, a solution containing a surface treatment agent such as a coupling agent is applied to one side or both sides of the self-supporting film thus obtained.

The solvent (application solvent) to be used for the surface treatment agent solution may be an organic solvent, which is a water-soluble liquid and has a surface tension of 32 mN/m or less at 20° C. and a boiling point of 125° C. or higher.

The “water-soluble liquid” as used herein refers to a liquid has the following characteristic:

A liquid mixture of the liquid and pure water in equal volumes, which is prepared by gently mixing the liquid with pure water and allowed to stand still at ordinary temperature and pressure (20° C., 1 atm), maintains the appearance of being homogeneous.
A water-soluble liquid may be preferably used as the application solvent in view of safety also.

The application solvent has a surface tension at 20° C. of 32 mN/m or less, preferably 31.5 mN/m or less, more preferably 31.3 mN/m or less. When the surface tension of the application solvent is excessively high, the surface treatment agent solution applied may be repelled, and the solution may not be evenly applied onto the surface of the self-supporting film, and therefore repelling marks may appear at the surface after curing and a polyimide film having an even surface may not be obtained. Meanwhile, the lower limit of the surface tension at 20° C. of the application solvent may be preferably, but not limited to, 20 mN/m or higher, more preferably 25 mN/m or higher. The surface tension may be determined by a capillary rise method, a ring method, a vertical plate method, a sessile drop method, and a bubble pressure method, for example.

The application solvent has a boiling point of 125° C. or higher, preferably 130° C. or higher, more preferably 140° C. or higher, further preferably 150° C. or higher, particularly preferably 160° C. or higher. When the boiling point of the solvent is excessively low, the solvent may evaporate too quickly after applying the surface treatment agent solution onto the self-supporting film, and therefore the time period for which the solvent remains at the surface as a site for the reaction of the surface treatment agent may be insufficient and the properties of the obtained film may be impaired. The specific rate of evaporation of the solvent to be used in the present invention may be preferably 0.5 or less, more preferably 0.4 or less, relative to n-butyl acetate, which is set at 1. The rate of evaporation is generally expressed by the percentage of evaporated solvent (wt %) and the time required for the solvent to evaporate to the percentage. In addition, the rate of evaporation is generally expressed as the specific rate of evaporation relative to a standard solvent such as n-butyl acetate. The rate of evaporation and the specific rate of evaporation may be measured in accordance with ASTM D3539-87.

The solvent must evaporate during heat treatment for imidization. In the case of the continuous production of polyimide film, it is preferred that a surface treatment agent solution is applied onto a surface of a self-supporting film, and then the film is dried in a coater oven and subjected to heat treatment for imidization in a curing oven. Accordingly, the solvent may preferably have a boiling point of 300° C. or lower, more preferably 250° C. or lower, particularly preferably 220° C. or lower.

A solvent which has the following characteristic may be preferably used as the application solvent:

No cracks are observed in the film, which is prepared by

applying a solution of a polyamic acid, which is prepared by reacting a tetracarboxylic acid component and a diamine component identical to those used for the production of polyimide film, on a glass substrate so that the thickness of the final polyimide film after curing may be within a range of from 10 μm to 14 μm,

heating and drying the solution to form a self-supporting film, which is peeled from the glass substrate, wherein the self-supporting film has a weight loss on heating of from 39 wt % to 43 wt % and an imidization rate of from 7% to 9% in the side which was in contact with the glass substrate (hereinafter, also referred to as “Side B”),

applying the application solvent to the Side B; and

immediately heating the applied film at a temperature of 200° C. or higher, while fixing all edges of the film with a pin tenter.

The application solvent may preferably have a flash point of 21° C. or higher, more preferably 70° C. or higher, at 1 atm. In view of safety, a solvent having a lower flash point may be difficult to use in industrial film-forming processes.

The application solvent may preferably have a contact angle of 61° or less, more preferably 60.5° or less, at 23° C. When the application solvent has a contact angle within the above-mentioned range, a polyimide film having excellent properties may be obtained. The lower limit of the contact angle of the application solvent may be preferably, but not limited to, 40° or more, more preferably 50° or more, at 23° C. The “contact angle of the application solvent” as used herein is defined as the contact angle of the solvent on a polytetrafluoroethylene sheet which may be measured, for example, by a contact angle meter “CA-X” made by Kyowa Interface Science Co., Ltd.

There are no particular restrictions to the application solvent, so long as the solvent has the properties as described above. Examples of the application solvent include

(1) glycol monoalkyl ethers such as ethylene glycol monoethyl ether, ethylene glycol mono-n-butyl ether, diethylene glycol monoethyl ether, and diethylene glycol mono-n-butyl ether;
(2) ether alcohols, for example, glycol dialkyl ethers such as diethylene glycol dimethyl ether, and diethylene glycol diethyl ether;
(3) ether esters such as diethylene glycol monoethyl ether acetate; and
(4) ketones such as diacetone alcohol.

Among others, glycol monoalkyl ethers such as ethylene glycol monoethyl ether and ethylene glycol mono-n-butyl ether, ether esters such as diethylene glycol monoethyl ether acetate, and ketones such as diacetone alcohol may be preferably used.

Among others, at least one selected from the group consisting of ethylene glycol monoethyl ether, ethylene glycol mono-n-butyl ether, diethylene glycol monoethyl ether acetate and diacetone alcohol may be preferably used.

The application solvent may be a mixture of two or more solvents.

The application solvent may contain other organic solvents, for example, amides such as N,N-dimethyl acetamide, N,N-diethyl acetamide and N,N-dimethyl formamide, and alcohols such as alcohols having 1 to 6 carbon atoms, so long as the application solvent meet the requirements as described above. The amount of the other organic solvents may be preferably 25 wt % or less, more preferably 10 wt % or less, based on the total weight of the solvent contained in the surface treatment agent solution. According to the present invention, even when the application solvent contains no surfactant, a surface treatment agent may be applied to a solidified film. Alternatively, a surface treatment agent may be applied to a solidified film, using a surfactant. In general, the addition of a surfactant tends to decrease the surface tension. Examples of the surfactant include silicone-based surfactants, fluorine-based surfactants, and hydrocarbon-based surfactants. The surfactant may preferably decompose/volatilize during heat treatment for imidization.

A solvent which does not or very little seep into the self-supporting film may be selected and used as the application solvent to provide a polyimide film having excellent adhesiveness, because the surface treatment agent is localized to the surface of the film.

The content of water in the surface treatment agent solution, which is applied to the self-supporting film, may be preferably 20 wt % or less, more preferably 10 wt % or less, particularly preferably 5 wt % or less.

Examples of the surface treatment agent include various surface treatment agents that improve adhesiveness or adherence, and include various coupling agents and chelating agents such as a silane-based coupling agent, a borane-based coupling agent, an aluminium-based coupling agent, an aluminium-based chelating agent, a titanate-based coupling agent, a iron-based coupling agent, and a copper-based coupling agent. These surface treatment agents may be used alone or in combination of two or more.

A coupling agent such as a silane coupling agent may be preferably used as the surface treatment agent.

Examples of the silane-based coupling agent include epoxysilane-based coupling agents such as γ-glycidoxypropyl trimethoxy silane, γ-glycidoxypropyl methyl diethoxy silane, and β-(3,4-epoxycyclohexyl)ethyl trimethoxy silane; vinylsilane-based coupling agents such as vinyl trichloro silane, vinyl tris(β-methoxy ethoxy) silane, vinyl triethoxy silane, and vinyl trimethoxy silane; acrylsilane-based coupling agents such as γ-methacryloxypropyl trimethoxy silane; aminosilane-based coupling agents such as N-β-(aminoethyl)-γ-aminopropyl trimethoxy silane, N-β-(aminoethyl)-γ-aminopropylmethyl dimethoxy silane, N-phenyl-γ-aminopropyl triethoxy silane, and N-phenyl-γ-aminopropyl trimethoxy silane, N-β-(aminoethyl)-γ-aminopropyl triethoxy silane, N-(aminocarbonyl)-γ-aminopropyl triethoxy silane, N-[β-(phenylamino)-ethyl]-γ-aminopropyl triethoxy silane, γ-aminopropyl triethoxy silane, γ-aminopropyl trimethoxy silane, and N-β-(aminoethyl)-γ-aminopropyl trimethoxy silane; mercapto-based silane coupling agents such as γ-mercaptopropyl trimethoxy silane, γ-mercaptopropyl triethoxy silane, γ-mercaptopropylmethyl dimethoxy silane, and γ-mercaptopropylmethyl diethoxy silane; and γ-chloropropyl trimethoxy silane.

Examples of the titanate-based coupling agent include isopropyl triisostearoyl titanate, isopropyl tridecyl benzenesulfonyl titanate, isopropyl tris(dioctyl pyrophosphate) titanate, tetraisopropyl bis(dioctyl phosphite) titanate, tetra(2,2-diallyloxymethyl-1-butyl) bis(di-tridecyl)phosphite titanate, bis(dioctyl pyrophosphate) oxyacetate titanate, bis(dioctyl pyrophosphate)ethylene titanate, isopropyl trioctanoyl titanate, and isopropyl tricumyl phenyl titanate.

The coupling agent may be preferably a silane-based coupling agent, particularly preferably an aminosilane-based coupling agent, for example, N-β-(aminoethyl)-γ-aminopropyl-triethoxy silane, N-(aminocarbonyl)-γ-aminopropyl triethoxy silane, N-[β-(phenylamino)-ethyl]-γ-aminopropyl triethoxy silane, N-phenyl-γ-aminopropyl triethoxy silane, or N-phenyl-γ-aminopropyl trimethoxy silane, N-β-(aminoethyl)-γ-aminopropyl-trimethoxy silane, γ-aminopropyl-trimethoxy silane, or γ-aminopropyl-triethoxy silane. Among them, N-phenyl-γ-aminopropyl trimethoxy silane, N-β-(aminoethyl)-γ-aminopropyl-trimethoxy silane, or γ-aminopropyl-trimethoxy silane may be particularly preferred.

The content of the surface treatment agent (e.g. a coupling agent and a chelating agent) in the surface treatment agent solution may be preferably within a range of from 0.1 wt % to 60 wt %, more preferably from 0.3 wt % to 20 wt %, particularly preferably from 0.5 wt % to 15 wt %, further preferably from 1 wt % to 10 wt %.

When an adhesive is laminated directly on the surface of the polyimide film to which the surface treatment agent is applied, the content of the surface treatment agent in the surface treatment agent solution may be preferably within a range of from 0.1 wt % to 60 wt %, more preferably from 0.3 wt % to 20 wt %, further preferably from 0.5 wt % to 10 wt %, particularly preferably from 1 wt % to 5 wt %. When a metal is laminated by a metallizing method directly on the surface of the polyimide film to which the surface treatment agent is applied, the content of the surface treatment agent in the surface treatment agent solution may be preferably within a range of from 0.5 wt % to 60 wt %, more preferably from 1 wt % to 20 wt %, particularly preferably from 1 wt % to 15 wt %, further preferably from 2 wt % to 10 wt %. When a metal is laminated by a wet plating method directly on the surface of the polyimide film to which the surface treatment agent is applied, the content of the surface treatment agent in the surface treatment agent solution may be preferably within a range of from 1 wt % to 60 wt %, more preferably from 2 wt % to 20 wt %, particularly preferably from 2 wt % to 15 wt %, further preferably from 2 wt % to 10 wt %.

There are no particular restrictions to the rotational viscosity (solution viscosity measured with a rotation viscometer at a temperature of 25° C.) of the surface treatment agent solution, so long as the solution may be applied to the self-supporting film. The surface treatment agent solution may preferably have a rotational viscosity of from 0.5 centipoise to 50,000 centipoise.

The surface treatment agent solution may contain other additive components in addition to a surface treatment agent, so long as the characteristics of the present invention would not be impaired.

The amount of the surface treatment agent solution to be applied may be appropriately determined, and may be preferably 1 g/m² to 50 g/m², more preferably 2 g/m² to 30 g/m², particularly preferably 3 g/m² to 20 g/m², for example, for both the surface of the self-supporting film which was in contact with the support and the opposite surface. The amount of the surface treatment agent solution to be applied to one side may be the same as, or different from the amount of the surface treatment agent solution to be applied to the other side. There are no particular restrictions to the temperature at which the surface treatment agent solution is applied to the self-supporting film, so long as the application may be performed without any trouble. The temperature may be appropriately selected.

The surface treatment agent solution may be applied to the self-supporting film by any known method; for example, by gravure coating, spin coating, silk screen coating, dip coating, spray coating, bar coating, knife coating, roll coating, blade coating, and die coating and the like.

According to the present invention, the self-supporting film on which the surface treatment agent solution is applied is then heated to provide a polyimide film.

The suitable heat treatment may be a process in which polymer imidization and solvent evaporation/removal are gradually conducted at about 100 to 400° C. for about 0.05 to 5 hr., particularly preferably 0.1 to 3 hr. as the first step. This heat treatment is particularly preferably conducted stepwise, that is, the first heat treatment at a relatively low temperature of about 100 to 170° C. for about 0.5 to 30 min, then the second heat treatment at a temperature of 170 to 220° C. for about 0.5 to 30 min, and then the third heat treatment at a high temperature of 220 to 400° C. for about 0.5 to 30 min. As necessary, the fourth high-temperature heat treatment at a high temperature of 400 to 550° C. may be conducted.

During heat treatment for imidization, at least both edges of a long solidified film in the direction perpendicular to the length direction, i.e. in the width direction, may be fixed with a pin tenter, a clip or a frame, for example, and the solidified film may be stretched and/or shrunk in the width direction and/or in the length direction, as necessary, in a curing oven.

The thickness of the polyimide film of the present invention may be, but not limited to, from about 3 μm to about 250 μm, preferably from about 4 μm to about 150 μm, more preferably from about 5 μm to about 125 μm, further preferably from about 5 μm to about 100 μm. According to the present invention, there may be provided a thin polyimide film having a thickness of 20 μm or less, further 15 μm or less, further 10 μm or less and exhibiting excellent adhesiveness. There may be provided a thin polyimide film having a thickness of from 6 μm to 16 μm and exhibiting excellent adhesiveness

The surface of the polyimide film of the present invention to which the surface treatment agent is applied may be further subjected to a treatment such as sand blast treatment, corona treatment, plasma treatment, and etching treatment.

In the polyimide film of the present invention, a compound derived from the surface treatment agent (e.g. Si when using a silane coupling agent) is localized to the surface. According to the present invention, when a silane coupling agent solution is applied to a self-supporting film, there may be provided a polyimide film which has a layer with a high content of Si and a thickness of from 1 nm to 1 μm, preferably from 5 nm to 900 nm, more preferably from 10 nm to 800 nm, particularly preferably from 20 nm to 700 nm, at the surface to which the silane coupling agent solution is applied, for example. The thickness of the segregation layer at the surface may be determined by observation of the cross section of the polyimide film with a transmission electron microscope.

In addition, there may be provided, for example, a polyimide film wherein the amount of Si in at least one surface is within a range of from 0.1% to 50%, preferably from 1% to 20%, particularly preferably from 2% to 15%, more preferably from 3% to 10% in terms of Si atom. The Si amount in a surface of a polyimide film may be measured by a scanning X-ray photoelectron spectrometer.

The surface of the polyimide film of the present invention to which the surface treatment agent is applied may have improved adhesiveness to an adhesive. Therefore, an adhesive layer may be formed directly on the surface of the polyimide film to which the surface treatment agent is applied, to provide a polyimide laminate which has high peel strength between the polyimide film and the adhesive layer in the initial state, and still has high peel strength, with preventing the reduction in peel strength, after high temperature treatment or after high temperature/high humidity treatment. The thickness of the polyimide film in the polyimide laminate may be, but not limited to, 25 μm or less, further 20 μm or less, further 15 μm or less, for example.

The polyimide laminate may be laminated via the adhesive layer onto another substrate such as a glass substrate, ceramics, e.g. a silicon wafer, a metal foil, a plastic film, and a woven or non-woven fabric of carbon fiber, glass fiber, resin fiber or the like. Another substrate may be laminated onto the adhesive layer of the polyimide laminate, which is formed on the surface of the polyimide film to which the surface treatment agent is applied, by a pressing member or a heating/pressing member.

Examples of the pressing member and the heating/pressing member include a pair of press metal rolls in which the press part may be made of either a metal or a ceramic sprayed coating metal, a double-belt press, and a hot-press. A preferable pressing member may be one capable of conducting thermo-compression bonding and cooling under pressure. Among others, preferred is a hydraulic-pressing type double-belt press.

The surface of the polyimide film to which the surface treatment agent is applied may have improved adhesiveness and adherence. In addition to the above-mentioned substrates, a photosensitive material, a thermocompression-bondable material and the like may be laminated directly onto the surface of the polyimide film.

Any heat-resistant adhesives used in the electric/electronic field such as polyimide, epoxy, acrylic, polyamide and urethane may be used as the adhesive, without limitation. Examples of the adhesive include heat-resistant adhesives such as polyimide adhesives, epoxy-modified polyimide adhesives, phenol-modified epoxy resin adhesives, epoxy-modified acrylic resin adhesives, and epoxy-modified polyamide adhesives.

The adhesive layer may be formed by any method used in electronics field. For example, an adhesive solution may be applied on the surface of the polyimide film to which the surface treatment agent is applied, followed by drying. Alternatively, an adhesive film, which is separately formed, may be laminated onto the surface of the polyimide film.

A metal foil which is bonded onto the polyimide film may be a foil of either a single metal or an alloy, including a copper foil, an aluminum foil, a gold foil, a silver foil, a nickel foil and a stainless steel foil. A preferable metal foil may be a copper foil such as a rolled copper foil and an electrolytic copper foil. The thickness of the metal foil may be preferably, but not limited to, from 0.1 μm to 10 mm, particularly preferably from 10 μm to 60 μm.

When using an ultrathin substrate having a thickness of from 1 μm to 10 μm, a metal carrier, a plastic carrier, or the like may be used to enhance handling characteristics.

The surface of the polyimide film of the present invention to which the surface treatment agent is applied may have improved adhesiveness to a metal. Therefore, a metal layer may be formed by a metallizing method or a wet plating method directly on the surface of the polyimide film to which the surface treatment agent is applied, to provide a polyimide-metal laminate which has high peel strength between the polyimide film and the metal layer in the initial state, and still has high peel strength, with preventing the reduction in peel strength, after high temperature treatment or after high temperature/high humidity treatment. A laminate prepared by laminating a metal layer directly on the polyimide film by a wet plating method may have higher peel strength after high temperature treatment than before high temperature treatment.

The “metallizing method” as used herein is a method for forming a metal layer, which is different from a wet plating method and a metal foil-lamination, and any known method such as vacuum vapor deposition, sputtering, ion plating and electron-beam evaporation may be employed.

Examples of the metal to be used in the metallizing method include, but not limited to, metals such as copper, nickel, chromium, manganese, aluminum, iron, molybdenum, cobalt, tungsten, vanadium, titanium and tantalum, and alloys thereof, and oxides of these metals and carbides of these metals.

The thickness of the metal layer formed by a metallizing method may be appropriately selected depending on the intended use, and may be preferably from 1 nm to 1000 nm, more preferably from 5 nm to 500 nm for a practical use.

The number of metal layers formed by a metallizing method may be appropriately selected depending on the intended use, and may be one, two, multi such as three or more layers.

As for the metal to be used in the metallizing method, it is preferred that a metal, for example, nickel, chromium, manganese, aluminum, iron, molybdenum, cobalt, tungsten, vanadium, titanium or tantalum, or an alloy thereof, or an oxide thereof, or a carbide thereof is used for the first layer, and copper, or an alloy of copper, or an oxide thereof, or a carbide thereof is used for the second layer. A metal layer, e.g. copper layer, having a thickness of from about 1 μm to about 40 μm may be formed on the second layer by a wet plating method.

Any known wet plating method may be employed. Examples of the wet plating method include electrolytic plating and electroless plating, and a combination of electrolytic plating and electroless plating may be also employed.

There are no particular restrictions to the metal to be used in the wet plating method, so long as it is applicable to wet plating.

The thickness of the metal layer formed by a wet plating method may be appropriately selected depending on the intended use, and may be preferably from 0.1 μm to 50 μm, more preferably from 1 μm to 30 μm for a practical use.

The number of metal layers formed by a wet plating method may be appropriately selected depending on the intended use, and may be one, two, multi such as three or more layers.

Any known wet plating process may be employed as the wet plating method, without limitation. One example of the processes is the “ELFSEED process” of EBARA-UDYLITE Co., Ltd. Another example of the processes is a process in which electroless copper plating is performed after the surface treatment process, “Catalyst Bond process” of Nippon Mining & Metals Co., Ltd.

In the “ELFSEED process” (EBARA-UDYLITE Co., Ltd.), the surface of the polyimide film is modified; a catalyst is provided to the surface and reduced; and then electroless nickel plating is performed. After the process completes, electrolytic copper plating may be performed to form a conductive metal layer. In order to ensure the adhesion of the electroless nickel plating layer to the electrolytic copper plating layer, an electroless copper plating layer may be formed between the electroless nickel plating layer and the electrolytic copper plating layer, for example, by copper reduction plating or copper displacement plating. The step to activate the electroless nickel plating film may be performed prior to electroless copper plating or electrolytic copper plating.

The “Catalyst Bond process” (Nippon Mining & Metals Co., Ltd.) is a pre-treatment process for plating. By the pre-treatment, the adsorption of palladium as a wet plating catalyst may be enhanced. After the process completes, a conductive metal layer may be formed by providing the surface with a catalyst, and then performing electroless copper plating and electrolytic copper plating.

The polyimide film, the polyimide-metal laminate, and the polyimide laminate according to the present invention may be used as a material for electronic components and electronic devices, including a printed wiring board, a flexible printed circuit board, a TAB tape, a COF tape, a metal wiring, and the like, as well as a cover material for a metal wiring, a chip such as an IC chip and the like, and a base material for a liquid crystal display, an organic electroluminescent display, an electronic paper, a solar cell and the like.

The coefficient of thermal expansion of the polyimide film may be appropriately selected depending on the intended use. In general, it is preferred that a polyimide film has a coefficient of thermal expansion close to that of a metal wiring and a chip such as an IC chip when using the polyimide film as an insulating substrate material for FPC, TAB, COF, a metal-wiring board and the like, and a cover material for a metal wiring, a chip such as an IC chip and the like, for example. Specifically, a polyimide film may preferably have a coefficient of thermal expansion (both MD and TD) of 40 ppm/° C. or less, more preferably from 0 ppm/° C. to 30 ppm/° C., further preferably from 5 ppm/° C. to 25 ppm/° C., particularly preferably from 8 ppm/° C. to 20 ppm/° C.

In some applications such as COF and interposer, it is preferred that a polyimide film has a coefficient of thermal expansion close to that of glass and silicon. According to the present invention, there may be provided a polyimide film having a coefficient of thermal expansion of from 0 ppm/° C. to 10 ppm/° C.

### EXAMPLES

The present invention will be described in more detail below with reference to the Examples. However, the present invention is not limited to these Examples.

The properties of polyimide films were evaluated as follows.

a) The peel strengths means the 90° peel strengths, and were measured at a peel speed of 50 mm/min in an atmosphere at 23° C. and 50% RH.

b) As for the surface of the polyimide film, the air side when the polyamic acid solution was cast on the support was taken as Side A, while the support side was taken as Side B.

c) The modes of peeling of the adherends from the polyimides were observed and expressed by 1) to 4) as described below in the “peel strength of the polyimide laminate” and “peel strength of the polyimide-metal laminate” columns in the Tables.

1) Combination of polyimide/adhesive interface delamination (with the adhesive white-turbid) and adhesive cohesive failure
2) Adhesive cohesive failure
3) Polyimide/adhesive interface delamination
4) Polyimide/adhesive interface delamination with the adhesive white-turbid

It is assumed that the adhesion is better in order of peeling mode 3)<4)<1)≦2). However, a simple comparison may not be made of difference in treatments among the initial peeling mode, the peeling mode after heat treatment, and the peeling mode after high temperature/high humidity treatment. Accordingly, a comparison may be preferably made in the same treatment.

### (1) Measurement of Peel Strength of Polyimide Laminate (A) (Coverlay)

<Preparation of Polyimide Laminate (A)>

A coverlay “CVA0525KA” made by Arisawa Mfg. Co., Ltd. was laminated on the surface of the polyimide film, to which the surface treatment agent is applied, by pressing at a temperature of 180° C. and a pressure of 3 MPa for 30 min to provide a polyimide laminate (A).

<Measurement of Peel Strength>

The peel strength of the polyimide laminate (A) was measured. This measured peel strength was referred to as “initial peel strength (A)”.

The polyimide laminate (A) was heated in a hot-air dryer at 150° C. for 24 hr. And then, the peel strength was measured. This measured peel strength was referred to as “peel strength after heat treatment (A)”.

### (2) Measurement of Peel Strength of Polyimide Laminate (B) (Three-Layer Laminate of Polyimide Film/Adhesive Layer/Copper Foil)

<Preparation of Polyimide Laminate (B)>

An acrylic adhesive (“Pyralux LF0100”) made by Du Pont and a rolled copper foil (“BHY-13H-T”, thickness: 18 μm) made by Nippon Mining & Metals Co., Ltd. in that order were laminated on the surface of the polyimide film, to which the surface treatment agent is applied, by pressing at a temperature of 180° C. and a pressure of 9 MPa for 5 min, and then heating at a temperature of 180° C. for 60 min to provide a polyimide laminate (B).

<Measurement of Peel Strength>

The peel strength of the polyimide laminate (B) was measured. This measured peel strength was referred to as “initial peel strength (B)”.

The polyimide laminate (B) was heated in a hot-air dryer at 150° C. for 24 hr. And then, the peel strength was measured. This measured peel strength was referred to as “peel strength after heat treatment (B1)”.

The polyimide laminate (B) was heated in a hot-air dryer at 150° C. for 168 hr. And then, the peel strength was measured. This measured peel strength was referred to as “peel strength after heat treatment (B2)”.

The polyimide laminate (B) was treated in an atmosphere at 121° C. and 100% RH for 24 hr, using a pressure cooker tester. And then, the peel strength was measured. This measured peel strength was referred to as “cooker peel strength (B1)”.

The polyimide laminate (B) was treated in an atmosphere at 121° C. and 100% RH for 96 hr, using a pressure cooker tester. And then, the peel strength was measured. This measured peel strength was referred to as “cooker peel strength (B2)”.

### (3) Measurement of Peel Strength of Polyimide-Metal Laminate (C) (Metallizing Method)

<Preparation of Polyimide-Metal Laminate (C)>

A Ni/Cr (weight ratio: 8/2) layer having a thickness of 25 nm was formed as the first layer on the surface of the polyimide film, to which the surface treatment agent is applied, by a conventional sputtering method. Subsequently, a copper layer having a thickness of 400 nm was formed as the second layer on the first layer by a conventional sputtering method. And then, a copper-plating layer having a thickness of 20 μm was formed on the copper layer to provide a polyimide-metal laminate (C).

<Measurement of Peel Strength>

The peel strength of the polyimide-metal laminate (C) was measured. This measured peel strength was referred to as “initial peel strength (C)”.

The polyimide-metal laminate (C) was heated in a hot-air dryer at 150° C. for 24 hr. And then, the peel strength was measured. This measured peel strength was referred to as “peel strength after heat treatment (C1)”.

The polyimide-metal laminate (C) was heated in a hot-air dryer at 150° C. for 168 hr. And then, the peel strength was measured. This measured peel strength was referred to as “peel strength after heat treatment (C2)”.

The polyimide-metal laminate (C) was treated in an atmosphere at 121° C. and 100% RH for 24 hr, using a pressure cooker tester. And then, the peel strength was measured. This measured peel strength was referred to as “cooker peel strength (C1)”.

The polyimide-metal laminate (C) was treated in an atmosphere at 121° C. and 100% RH for 96 hr, using a pressure cooker tester. And then, the peel strength was measured. This measured peel strength was referred to as “cooker peel strength (C2)”.

### (4) Measurement of Peel Strength of Polyimide-Metal Laminate (D) (Wet Plating Method)

<Preparation of Polyimide-Metal Laminate (D)>

A electroless nickel plating layer and a electrolytic copper plating layer in that order were formed on the surface of the polyimide film, to which the surface treatment agent is applied, by a wet plating process (“ELFSEED process” of EBARA-UDYLITE Co., Ltd.). And then, the laminate was heated at a temperature of 65° C. for 30 min to provide a polyimide-metal laminate (D) having a copper thickness of 10 μm.

<Measurement of Peel Strength>

The peel strength of the polyimide-metal laminate (D) was measured. This measured peel strength was referred to as “initial peel strength (D)”.

The polyimide-metal laminate (D) was heated in a hot-air dryer at 150° C. for 24 hr. And then, the peel strength was measured. This measured peel strength was referred to as “peel strength after heat treatment (D1)”.

The polyimide-metal laminate (D) was heated in a hot-air dryer at 150° C. for 168 hr. And then, the peel strength was measured. This measured peel strength was referred to as “peel strength after heat treatment (D2)”.

<Preparation of Application Solutions>

The solutions to be applied to the self-supporting films (application solutions) were prepared by mixing an application solvent, a silane coupling agent as a surface treatment agent and a surfactant (“L7001” made by Dow Corning Toray Co., Ltd.) in the ratios shown in Table 1 and stirring the resulting mixtures at room temperature to provide homogeneous solutions.

TABLE 1

| | | Surface treatment agent | | L7001 |
|---|---|---|---|---|
| | | | Concentration | Concentration |
| | Application solvent | Type | wt % | ppm |
| Application | ethylene glycol mono-n-butyl ether | N-phenyl-3-aminopropyl trimethoxy silane | 1.0 | 0 |
| solution 1 | | | | |
| Application | ethylene glycol mono-n-butyl ether | N-phenyl-3-aminopropyl trimethoxy silane | 3.5 | 0 |
| solution 2 | | | | |
| Application | N,N-dimethylacetamide (DMAc) | N-phenyl-3-aminopropyl trimethoxy silane | 3.5 | 25 |
| solution 3 | | | | |
| Application | ethylene glycol mono-n-butyl ether | N-phenyl-3-aminopropyl trimethoxy silane | 7.0 | 0 |
| solution 4 | | | | |
| Application | ethylene glycol mono-n-butyl ether/ | N-phenyl-3-aminopropyl trimethoxy silane | 1.0 | 0 |
| solution 5 | DMAc (DMAc: 5 wt %) | | | |
| Application | diacetone alcohol | N-phenyl-3-aminopropyl trimethoxy silane | 3.5 | 0 |
| solution 6 | | | | |
| Application | diethylene glycol monoethyl ether | N-phenyl-3-aminopropyl trimethoxy silane | 3.5 | 0 |
| solution 7 | acetate | | | |
| Application | ethylene glycol monoethyl ether | N-phenyl-3-aminopropyl trimethoxy silane | 3.5 | 0 |
| solution 8 | | | | |
| Application | ethylene glycol mono-n-butyl ether | N-phenyl-3-aminopropyl trimethoxy silane | 0.35 | 0 |
| solution 9 | | | | |
| Application | ethylene glycol mono-n-butyl ether | N-2-(aminoethyl)-3-aminopropyl trimethoxy | 3.1 | 0 |
| solution 10 | | silane | | |
| Application | ethylene glycol mono-n-butyl ether | 3-aminopropyl trimethoxy silane | 2.5 | 0 |
| solution 11 | | | | |
| Application | ethylene glycol mono-n-butyl ether | N-phenyl-3-aminopropyl trimethoxy silane | 0.35 | 25 |
| solution 12 | | | | |
| Application | ethylene glycol mono-n-butyl ether | N-phenyl-3-aminopropyl trimethoxy silane | 3.5 | 25 |
| solution 13 | | | | |
| Application | diacetone alcohol | N-phenyl-3-aminopropyl trimethoxy silane | 3.5 | 30 |
| solution 14 | | | | |
| Application | diethylene glycol monoethyl ether | N-phenyl-3-aminopropyl trimethoxy silane | 3.5 | 25 |
| solution 15 | acetate | | | |
| Application | diethylene glycol monomethyl ether | N-phenyl-3-aminopropyl trimethoxy silane | 3.5 | 0 |
| solution 16 | | | | |
| Application | ethylene glycol | N-phenyl-3-aminopropyl trimethoxy silane | 3.5 | 0 |
| solution 17 | | | | |

### <Preparation of Polyamic Acid Solution (A)>

Into a polymerization tank were placed the predetermined amounts of N,N-dimethylacetamide (DMAc) and p-phenylenediamine (PPD). And then, while stirring at a temperature of 40° C., 3,3′,4,4′-biphenyltetracarboxylic dianhydride (s-BPDA) was stepwise added to the resulting mixture until the molar amount of s-BPDA was substantially equal to the molar amount of PPD, and s-BPDA and PPD were reacted, to provide a polymerization solution of a polyamic acid (polyimide precursor solution) having a solid content of 18 wt %. To the polyamic acid polymerization solution were added 0.25 parts by weight of triethanolamine salt of monostearyl phosphate and 0.3 parts by weight of colloidal silica relative to 100 parts by weight of the polyamic acid. The resulting mixture was homogeneously mixed, to provide a polyamic acid solution (A). The polyamic acid solution (A) had a rotational viscosity of 180 Pa·s at 30° C.

### <Preparation of Polyamic Acid Solution Composition (A)>

To the polyamic acid solution (A) was added 0.05 equivalents of 1,2-dimethylimidazole relative to the amide acid unit, to provide a polyamic acid solution composition (A).

### <Preparation of Polyamic Acid Solution Composition (B)>

To the polyamic acid solution (A) was added 0.10 equivalents of 1,2-dimethylimidazole relative to the amide acid unit, to provide a polyamic acid solution composition (B).

### <Measurement of Imidization Rate of Self-Supporting Film>

FT-IR spectra of a self-supporting film and the fully-cured film thereof (polyimide film) were measured according to the multiple reflection ATR method with a Ge crystal at an incident angle of 45°, using FT/IR6100 made by Jasco Corporation. The imidization rate was calculated by the following formula (I) based on the ratio of the peak height of an asymmetric stretching vibration of an imide carbonyl group at 1775 cm¹ to the peak height of a carbon-carbon symmetric stretching vibration of an aromatic ring at 1515 cm¹.

Imidization rate (%)={(X1/X2)/(Y1/Y2)}×100 (1)

wherein
X1 represents the peak height at 1775 cm⁻¹ of the self-supporting film;
X2 represents the peak height at 1515 cm⁻¹ of the self-supporting film;
Y1 represents the peak height at 1775 cm⁻¹ of the fully-cured film; and
Y2 represents the peak height at 1515 cm¹ of the fully-cured film.

The self-supporting films used in Examples, Comparative Examples and Reference Examples as described below had an imidization rate of from 7% to 55% unless specifically described.

### <Evaluation of Polyimide Laminate (A) (Coverlay)>

### Example 1

The polyamic acid solution composition (A) was continuously cast from a slit of a T-die mold on a smooth metal support in the form of belt in a drying oven, to form a thin film. The thin film was heated at a temperature of 145° C. for a predetermined time, and then peeled off from the support, to provide a self-supporting film. The self-supporting film thus obtained had a weight loss on heating of 29.0 wt %, a Side A imidization rate of 13.3% and a Side B imidization rate of 22.0%.

And then, while continuously conveying the self-supporting film, the application solution (1) was applied to the Side B of the self-supporting film, using a die coater (application amount: 6 g/m²). Subsequently, the self-supporting film was conveyed in a drying oven maintained at a temperature of 40° C. And then, the self-supporting film was fed into a continuous heating oven (curing oven) while fixing both edges of the film in the width direction, and the film was heated from 100° C. to the highest heating temperature of 480° C. to effect imidization, thereby producing a long polyimide film (PI-1) having an average thickness of 8 μm.

A polyimide laminate (A) (PI-1) in which the coverlay was laminated on the polyimide film was produced with the polyimide film (PI-1) in the same way as in the preparation of polyimide laminate (A). The peel strengths of the polyimide laminate (A) (PI-1) were measured, and the results are shown in Table 2.

### Example 2

A long polyimide film (PI-2) was produced in the same way as in Example 1, except that the application solution (2) was used, instead of the application solution (1). And then, a polyimide laminate (A) (PI-2) was produced in the same way as in Example 1. The peel strengths of the polyimide laminate (A) (PI-2) were measured, and the results are shown in Table 2.

### Comparative Example 1

A polyimide film (PI-3) was produced in the same way as in Example 1, except that the application solution (3) was used, instead of the application solution (1). When the application solution was applied to the self-supporting film, the application solution was repelled and cracks occurred, and repelling marks and cracks appeared in the film after curing and the obtained film did not have an even surface.

### Reference Example 1

A polyimide film (PI-4) was produced in the same way as in Example 1, except that no application solution was applied to the self-supporting film and the self-supporting film was not conveyed in a drying oven maintained at a temperature of 40° C. And then, a polyimide laminate (A) (PI-4) was produced in the same way as in Example 1. The peel strengths of the polyimide laminate (A) (PI-4) were measured, and the results are shown in Table 2.

### Example 3

The polyamic acid solution composition (A) was continuously cast from a slit of a T-die mold on a smooth metal support in the form of belt in a drying oven, to form a thin film. The thin film was heated at a temperature of 145° C. for a predetermined time, and then peeled off from the support, to provide a self-supporting film. The self-supporting film thus obtained had a weight loss on heating of 30.5 wt %, a Side A imidization rate of 11.5% and a Side B imidization rate of 30.2%.

And then, while continuously conveying the self-supporting film, the application solution (1) was applied to the Side B of the self-supporting film, using a die coater (application amount: 6 g/m²). Subsequently, the self-supporting film was conveyed in a drying oven maintained at a temperature of 40° C.

And then, the self-supporting film was fed into a continuous heating oven (curing oven) while fixing both edges of the film in the width direction, and the film was heated from 100° C. to the highest heating temperature of 480° C. to effect imidization, thereby producing a long polyimide film (PI-5) having an average thickness of 12.5 μm.

A polyimide laminate (A) (PI-5) in which the coverlay was laminated on the polyimide film was produced with the polyimide film (PI-5) in the same way as in the preparation of polyimide laminate (A). The peel strengths of the polyimide laminate (A) (PI-5) were measured, and the results are shown in Table 2.

### Example 4

A self-supporting film having a weight loss on heating of 29.0 wt %, a Side A imidization rate of 15.4% and a Side B imidization rate of 34.0% was produced in the same way as in Example 3. A polyimide film (PI-6) having an average thickness of 12.5 μm was produced in the same way as in Example 3, except that the application solution (2) was used as a solution to be applied to the self-supporting film.

A polyimide laminate (A) (PI-6) in which the coverlay was laminated on the polyimide film was produced with the polyimide film (PI-6) in the same way as in the preparation of polyimide laminate (A). The peel strengths of the polyimide laminate (A) (PI-6) were measured, and the results are shown in Table 2.

### Example 5

A long polyimide film (PI-7) having an average thickness of 12.5 μm was produced in the same way as in Example 3, except that the application solution (4) was used, instead of the application solution (1). And then, a polyimide laminate (A) (PI-7) was produced with the polyimide film (PI-7). The peel strengths of the polyimide laminate (A) (PI-7) were measured, and the results are shown in Table 2.

### Example 6

A long polyimide film (PI-8) having an average thickness of 12.5 μm was produced in the same way as in Example 3, except that the application solution (5) was used, instead of the application solution (1). And then, a polyimide laminate (A) (PI-8) was produced with the polyimide film (PI-8). The peel strengths of the polyimide laminate (A) (PI-8) were measured, and the results are shown in Table 2.

### Comparative Example 2

A polyimide film (PI-9) was produced in the same way as in Example 3, except that the application solution (3) was used, instead of the application solution (1). When the application solution was applied to the self-supporting film, the application solution was repelled, and repelling marks appeared in the film after curing and the obtained film did not have an even surface.

### Reference Example 2

A polyimide film (PI-10) was produced in the same way as in Example 3, except that no application solution was applied to the self-supporting film and the self-supporting film was not conveyed in a drying oven maintained at a temperature of 40° C. And then, a polyimide laminate (A) (PI-10) was produced with the polyimide film (PI-10). The peel strengths of the polyimide laminate (A) (PI-10) were measured, and the results are shown in Table 2.

### Example 7

The polyamic acid solution composition (A) was cast on a glass plate, to form a thin film. The thin film was heated at a temperature of 138° C. for 60 sec, using a hot plate, and then peeled off from the glass plate, to provide a self-supporting film having a weight loss on heating of 33.9 wt %, a Side A imidization rate of 14.9% and a Side B imidization rate of 24.3%.

And then, the application solution (6) was applied to the Side B of the self-supporting film, using a bar coater No. 3 (application amount: 6 g/m²). Subsequently, while fixing all edges of the self-supporting film with a pin tenter, the film was heated stepwise in an oven at 100° C. for 140 sec, 155° C. for 50 sec, 210° C. for 50 sec, 370° C. for 50 sec, and then 490° C. for 50 sec to effect imidization, thereby producing a polyimide film (PI-11) having an average thickness of 13 μm.

A polyimide laminate (A) (PI-11) in which the coverlay was laminated on the polyimide film was produced with the polyimide film (PI-11) in the same way as in the preparation of polyimide laminate (A). The peel strengths of the polyimide laminate (A) (PI-11) were measured, and the results are shown in Table 2.

### Example 8

A self-supporting film having a weight loss on heating of 33.3 wt % was produced in the same way as in Example 7. A polyimide film (PI-12) having an average thickness of 11 μm was produced in the same way as in Example 7, except that the application solution (2) was used as a solution to be applied to the self-supporting film.

A polyimide laminate (A) (PI-12) in which the coverlay was laminated on the polyimide film was produced with the polyimide film (PI-12) in the same way as in the preparation of polyimide laminate (A). The peel strengths of the polyimide laminate (A) (PI-12) were measured, and the results are shown in Table 2.

### Example 9

A self-supporting film having a weight loss on heating of 34.5 wt % was produced in the same way as in Example 7. A polyimide film (PI-13) having an average thickness of 13 μm was produced in the same way as in Example 7, except that the application solution (7) was used as a solution to be applied to the self-supporting film.

A polyimide laminate (A) (PI-13) in which the coverlay was laminated on the polyimide film was produced with the polyimide film (PI-13) in the same way as in the preparation of polyimide laminate (A). The peel strengths of the polyimide laminate (A) (PI-13) were measured, and the results are shown in Table 2.

### Example 10

A self-supporting film having a weight loss on heating of 35.6 wt % was produced in the same way as in Example 7. A polyimide film (PI-14) having an average thickness of 16 μm was produced in the same way as in Example 7, except that the application solution (8) was used as a solution to be applied to the self-supporting film.

A polyimide laminate (A) (PI-14) in which the coverlay was laminated on the polyimide film was produced with the polyimide film (PI-14) in the same way as in the preparation of polyimide laminate (A). The peel strengths of the polyimide laminate (A) (PI-14) were measured, and the results are shown in Table 2.

### Comparative Example 3

A self-supporting film having a weight loss on heating of 33.2 wt % was produced in the same way as in Example 7. And then, the application solution (3) was applied to the Side B of the self-supporting film, using a bar coater No. 3 (application amount: 6 g/m²). When the application solution was applied to the self-supporting film, the application solution was repelled. A polyimide film (PI-15) having an average thickness of 12 μm, which was obtained by curing in the same way as in Example 7, did not have an even surface in which repelling marks appeared.

### Reference Example 3

A self-supporting film having a weight loss on heating of 33.4 wt % was produced in the same way as in Example 7. And then, a polyimide film (PI-16) was produced in the same way as in Example 7, except that no application solution was applied to the self-supporting film.

A polyimide laminate (A) (PI-16) in which the coverlay was laminated on the polyimide film was produced with the polyimide film (PI-16) in the same way as in the preparation of polyimide laminate (A). The peel strengths of the polyimide laminate (A) (PI-16) were measured, and the results are shown in Table 2.

### Example 11

A self-supporting film having a weight loss on heating of 34.7 wt % was produced in the same way as in Example 7. And then, the application solution (6) was applied to the Side A of the self-supporting film, using a bar coater No. 3 (application amount: 6 g/m²). After that, a polyimide film (PI-17) having an average thickness of 14 μm was produced in the same way as in Example 7.

A polyimide laminate (A) (PI-17) in which the coverlay was laminated on the polyimide film was produced with the polyimide film (PI-17) in the same way as in the preparation of polyimide laminate (A). The peel strengths of the polyimide laminate (A) (PI-17) were measured, and the results are shown in Table 2.

### Example 12

A self-supporting film having a weight loss on heating of 31.5 wt % was produced in the same way as in Example 7. A polyimide film (PI-18) having an average thickness of 10 μm was produced in the same way as in Example 11, except that the application solution (2) was used as a solution to be applied to the self-supporting film.

A polyimide laminate (A) (PI-18) in which the coverlay was laminated on the polyimide film was produced with the polyimide film (PI-18) in the same way as in the preparation of polyimide laminate (A). The peel strengths of the polyimide laminate (A) (PI-18) were measured, and the results are shown in Table 2.

### Example 13

A self-supporting film having a weight loss on heating of 36.0 wt % was produced in the same way as in Example 7. A polyimide film (PI-19) having an average thickness of 14 μm was produced in the same way as in Example 11, except that the application solution (9) was used as a solution to be applied to the self-supporting film.

A polyimide laminate (A) (PI-19) in which the coverlay was laminated on the polyimide film was produced with the polyimide film (PI-19) in the same way as in the preparation of polyimide laminate (A). The peel strengths of the polyimide laminate (A) (PI-19) were measured, and the results are shown in Table 2.

### Example 14

The polyamic acid solution composition (A) was cast on a glass plate, to form a thin film. The thin film was heated at a temperature of 138° C. for 120 sec, using a hot plate, and then peeled off from the glass plate, to provide a self-supporting film having a weight loss on heating of 27.4 wt %, a Side A imidization rate of 17.7% and a Side B imidization rate of 25.0%.

And then, the application solution (10) was applied to the Side B of the self-supporting film, using a bar coater No. 3 (application amount: 6 g/m²). Subsequently, while fixing all edges of the self-supporting film with a pin tenter, the film was heated stepwise in an oven at 40° C. for 75 sec, 140° C. for 50 sec, 210° C. for 50 sec, 370° C. for 50 sec, and then 490° C. for 50 sec to effect imidization, thereby producing a polyimide film (PI-20) having an average thickness of 7 μm.

A polyimide laminate (A) (PI-20) in which the coverlay was laminated on the polyimide film was produced with the polyimide film (PI-20) in the same way as in the preparation of polyimide laminate (A). The peel strengths of the polyimide laminate (A) (PI-20) were measured, and the results are shown in Table 2.

### Example 15

A self-supporting film having a weight loss on heating of 28.3 wt % was produced in the same way as in Example 14. A polyimide film (PI-21) having an average thickness of 6 μm was produced in the same way as in Example 14, except that the application solution (11) was used as a solution to be applied to the self-supporting film.

A polyimide laminate (A) (PI-21) in which the coverlay was laminated on the polyimide film was produced with the polyimide film (PI-21) in the same way as in the preparation of polyimide laminate (A). The peel strengths of the polyimide laminate (A) (PI-21) were measured, and the results are shown in Table 2.

### Comparative Example 4

A self-supporting film having a weight loss on heating of 30.9 wt % was produced in the same way as in Example 14. And then, the application solution (3) was applied to the Side B of the self-supporting film, using a bar coater No. 3 (application amount: 6 g/m²). When the application solution was applied to the self-supporting film, the application solution was repelled. A polyimide film (PI-22) having an average thickness of 8 μm, which was obtained by curing in the same way as in Example 14, did not have an even surface in which repelling marks appeared.

### Reference Example 4

A self-supporting film having a weight loss on heating of 32.1 wt % was produced in the same way as in Example 14. And then, a polyimide film (PI-23) was produced in the same way as in Example 14, except that no application solution was applied to the self-supporting film.

A polyimide laminate (A) (PI-23) in which the coverlay was laminated on the polyimide film was produced with the polyimide film (PI-23) in the same way as in the preparation of polyimide laminate (A). The peel strengths of the polyimide laminate (A) (PI-23) were measured, and the results are shown in Table 2.

TABLE 2

| | | | | | | Peel strength of | |
|---|---|---|---|---|---|---|---|
| | | | | | | polyimide laminate (A) | |
| | Applied | | Appearance | Polyimide film | | (kN/m) | |
| | surface of | Application | of film after | | Thickness | | After heat |
| | film | solution | application | Type | (μm) | Initial | treatment (A) |
| Example 1 | Side B | Application | Good | PI-1 | 8 | 1.38 ¹⁾ | 1.20 ²⁾ |
| | | solution 1 | | | | | |
| Example 2 | Side B | Application | Good | PI-2 | 8 | 1.39 ¹⁾ | 1.11 ²⁾ |
| | | solution 2 | | | | | |
| Comparative | Side B | Application | Repelling, | PI-3 | 8 | — | — |
| Example 1 | | solution 3 | Cracks | | | | |
| Reference | — | — | — | PI-4 | 8 | 0.30 ³⁾ | 0.15 ³⁾ |
| Example 1 | | | | | | | |
| Example 3 | Side B | Application | Good | PI-5 | 12.5 | 1.99 ²⁾ | 1.10 ²⁾ |
| | | solution 1 | | | | | |
| Example 4 | Side B | Application | Good | PI-6 | 12.5 | 1.50 ¹⁾ | 1.11 ²⁾ |
| | | solution 2 | | | | | |
| Example 5 | Side B | Application | Good | PI-7 | 12.5 | 1.38 ¹⁾ | 0.75 ²⁾ |
| | | solution 4 | | | | | |
| Example 6 | Side B | Application | Good | PI-8 | 12.5 | 1.93 ²⁾ | 0.91 ²⁾ |
| | | solution 5 | | | | | |
| Comparative | Side B | Application | Repelling | PI-9 | 12.5 | — | — |
| Example 2 | | solution 3 | | | | | |
| Reference | — | — | — | PI-10 | 12.5 | 0.21 ³⁾ | 0.13 ³⁾ |
| Example 2 | | | | | | | |
| Example 7 | Side B | Application | Good | PI-11 | 13 | 1.30 ¹⁾ | 0.80 ²⁾ |
| | | solution 6 | | | | | |
| Example 8 | Side B | Application | Good | PI-12 | 11 | 0.91 ¹⁾ | 0.95 ²⁾ |
| | | solution 2 | | | | | |
| Example 9 | Side B | Application | Good | PI-13 | 13 | 0.88 ¹⁾ | 0.80 ²⁾ |
| | | solution 7 | | | | | |
| Example 10 | Side B | Application | Good | PI-14 | 16 | 1.67 ²⁾ | 0.66 ²⁾ |
| | | solution 8 | | | | | |
| Comparative | Side B | Application | Repelling | PI-15 | 12 | — | — |
| Example 3 | | solution 3 | | | | | |
| Reference | — | — | — | PI-16 | 12 | 0.25 ³⁾ | 0.16 ³⁾ |
| Example 3 | | | | | | | |
| Example 11 | Side A | Application | Good | PI-17 | 14 | 2.06 ²⁾ | 0.76 ²⁾ |
| | | solution 6 | | | | | |
| Example 12 | Side A | Application | Good | PI-18 | 10 | 1.64 ²⁾ | 0.77 ¹⁾ |
| | | solution 2 | | | | | |
| Example 13 | Side A | Application | Good | PI-19 | 14 | 0.82 ⁴⁾ | 0.77 ²⁾ |
| | | solution 9 | | | | | |
| Example 14 | Side B | Application | Good | PI-20 | 7 | 0.65 ⁴⁾ | 0.83 ⁴⁾ |
| | | solution 10 | | | | | |
| Example 15 | Side B | Application | Good | PI-21 | 6 | 0.58 ⁴⁾ | 1.01 ²⁾ |
| | | solution 11 | | | | | |
| Comparative | Side B | Application | Repelling | PI-22 | 8 | — | — |
| Example 4 | | solution 3 | | | | | |
| Reference | — | — | — | PI-23 | 7 | 0.07 ³⁾ | 0.02 ³⁾ |
| Example 4 | | | | | | | |

In Table 2,

1) As can be seen from the comparison of Examples 1-15 and Reference Examples 1-4, the films of Examples have both higher initial peel strength and higher peel strength after heat treatment than the films of Reference Examples. That appears to be due to the presence or absence of the application of a silane coupling agent solution.

2) As can be seen from Comparative Examples 1-4, in the case of a thin self-supporting film, when the application solution (3), which contains DMAc as a solvent, is applied to the self-supporting film, sometimes repelling and cracks occur at the surface of the film and the film is inferior in appearance, and a good polyimide film may not be reliably obtained. That appears to be due to the type of application solvent.

3) As can be seen from the comparison of Examples 7-10, the film of Example 8 has the highest peel strength after heat treatment, followed by Examples 7 and 9, and Example 10. That appears to be due to the type of application solvent.

4) As can be seen from the comparison of Examples 7-9 and Examples 11-13, the Side B of the film has higher peel strength after heat treatment. That appears to be caused by the effects of casting in the production of film.

5) As can be seen from Examples 3-5, the films of Examples 3 and 4 have higher peel strength after heat treatment. That appears to be due to the concentration of the surface treatment agent.

### <Evaluation of Polyimide Laminate (B) (Three-Layer Laminate of Polyimide Film/Adhesive Layer/Copper Foil)>

### Example 16

A self-supporting film was produced in the same way as in Example 1, except that the polyamic acid solution composition (B) was used. The self-supporting film thus obtained had a weight loss on heating of 29.6 wt %, a Side A imidization rate of 15.9% and a Side B imidization rate of 33.0%. A long polyimide film (PI-24) having an average thickness of 12.5 μm was produced in the same way as in Example 1, except that the application solution (12) was used as a solution to be applied to the self-supporting film.

A polyimide laminate (B) (polyimide film/adhesive layer/copper foil) (PI-24) in which the copper foil was laminated on the polyimide film via the adhesive layer was produced with the polyimide film (PI-24) in the same way as in the preparation of polyimide laminate (B). The peel strengths of the polyimide laminate (B) (PI-24) were measured, and the results are shown in Table 3.

### Example 17

A polyimide film (PI-25) was produced in the same way as in Example 16, except that the application solution (13) was used, instead of the application solution (12). And then, a polyimide laminate (B) (PI-25) in which the copper foil was laminated on the polyimide film via the adhesive layer was produced with the polyimide film (PI-25) in the same way as in the preparation of polyimide laminate (B). The peel strengths of the polyimide laminate (B) (PI-25) were measured, and the results are shown in Table 3.

### Comparative Example 5

A polyimide film (PI-26) was produced in the same way as in Example 16, except that the application solution (3) was used, instead of the application solution (12). When the application solution was applied to the self-supporting film, the application solution was repelled, and repelling marks appeared in the film after curing and the obtained film did not have an even surface.

### Reference Example 5

A polyimide film (PI-27) was produced in the same way as in Example 16, except that no application solution was applied to the self-supporting film and the self-supporting film was not conveyed in a drying oven maintained at a temperature of 40° C. And then, a polyimide laminate (B) (PI-27) in which the copper foil was laminated on the polyimide film via the adhesive layer was produced with the polyimide film (PI-27) in the same way as in the preparation of polyimide laminate (B). The peel strengths of the polyimide laminate (B) (PI-27) were measured, and the results are shown in Table 3.

### Example 18

The polyamic acid solution (A) was continuously cast from a slit of a T-die mold on a smooth metal support in a drying oven, to form a thin film. The thin film was heated at a temperature of 135° C. for a predetermined time, and then peeled off from the support, to provide a self-supporting film. The self-supporting film thus obtained had a weight loss on heating of 37.4 wt %, a Side A imidization rate of 10.0% and a Side B imidization rate of 18.8%.

And then, while continuously conveying the self-supporting film peeled, the application solution (12) was applied to the Side B of the self-supporting film, using a die coater (application amount: 6 g/m²). Subsequently, the self-supporting film was conveyed in a drying oven maintained at a temperature of 40° C. And then, the self-supporting film was fed into a continuous heating oven (curing oven) while fixing both edges of the film in the width direction, and the film was heated from 100° C. to the highest heating temperature of 480° C. to effect imidization, thereby producing a long polyimide film (PI-28) having an average thickness of 35 μm.

And then, a polyimide laminate (B) (PI-28) in which the copper foil was laminated on the polyimide film via the adhesive layer was produced with the polyimide film (PI-28) in the same way as in the preparation of polyimide laminate (B). The peel strengths of the polyimide laminate (B) (PI-28) were measured, and the results are shown in Table 3.

TABLE 3

| | | | | | | Peel strength of | | |
|---|---|---|---|---|---|---|---|---|
| | | | | | | polyimide laminate (B) | | |
| | Applied | | Appearance | Polyimide film | | (kN/m) | | |
| | surface of | Application | of film after | | Thickness | | After heat | Cooker |
| | film | solution | application | Type | (μm) | Initial | treatment (B1) | (B2) |
| Example 16 | Side B | Application | Good | PI-24 | 12.5 | 2.01 ²⁾ | 1.62 ²⁾ | 1.99 ²⁾ |
| | | solution 12 | | | | | | |
| Example 17 | Side B | Application | Good | PI-25 | 12.5 | 2.19 ²⁾ | 2.00 ²⁾ | 1.66 ²⁾ |
| | | solution 13 | | | | | | |
| Comparative | Side B | Application | Repelling | PI-26 | 12.5 | — | — | — |
| Example 5 | | solution 3 | | | | | | |
| Reference | — | — | — | PI-27 | 12.5 | 0.35 ³⁾ | 0.33 ³⁾ | 0.52 ⁴⁾ |
| Example 5 | | | | | | | | |
| Example 18 | Side B | Application | Good | PI-28 | 35 | 2.69 ²⁾ | 2.17 ²⁾ | 1.48 ²⁾ |
| | | solution 12 | | | | | | |

In Table 3,

1) As can be seen from Examples 16-18, the films of Examples have higher initial peel strength, and higher peel strengths after heat treatment and after high temperature/high humidity treatment, irrespective of thickness of the film. As compared with initial peel strength, the reduction in peel strengths after heat treatment or after high temperature/high humidity treatment is diminished.

### <Evaluation of Polyimide-Metal Laminate (C) (Metallizing Method)>

### Examples 19-22

Polyimide films (PI-30)-(PI-33) were produced in the same way as in Example 18, except that the application solutions shown in Table 4 were used, instead of the application solution (12). And then, polyimide-metal laminates (C) (polyimide film/copper foil) (PI-30)-(PI-33) in which the metals were laminated on the polyimide films by a metallizing method were produced with the polyimide films (PI-30)-(PI-33) in the same way as in the preparation of polyimide-metal laminate (C). The peel strengths of the polyimide-metal laminates (C) (PI-30)-(PI-33) were measured, and the results are shown in Table 4.

### Comparative Example 6

A polyimide film (PI-29) was produced in the same way as in Example 18, except that the application solution (3) was used, instead of the application solution (12). Unlike Comparative Example 1 etc., the obtained polyimide film (PI-29) had a good appearance due to the greater film thickness of 35 μm. The polyimide film (PI-29), however, had a low initial peel strength.

A polyimide-metal laminate (C) (PI-29) in which the metal was laminated on the polyimide film by a metallizing method was produced with the polyimide film (PI-29) in the same way as in the preparation of polyimide-metal laminate (C). The peel strengths of the polyimide-metal laminate (C) (PI-29) were measured, and the results are shown in Table 4.

TABLE 4

| | | | | | | Peel strength of polyimide-metal laminate (C) | | | | |
|---|---|---|---|---|---|---|---|---|---|---|
| | | | | | | (kN/m) | | | | |
| | Applied | | Appearance | Polyimide film | | | After heat | After heat | | |
| | surface | Application | of film after | | Thickness | | treatment | treatment | Cooker | Cooker |
| | of film | solution | application | Type | (μm) | Initial | (C1) | (C2) | (C1) | (C2) |
| Example 19 | Side B | Application | Good | PI-30 | 35 | 1.22 | 0.93 | 0.69 | 0.82 | 0.70 |
| | | solution 13 | | | | | | | | |
| Example 20 | Side B | Application | Good | PI-31 | 35 | 1.24 | 0.78 | 0.70 | 0.74 | 0.70 |
| | | solution 14 | | | | | | | | |
| Example 21 | Side B | Application | Good | PI-32 | 35 | 1.09 | 0.75 | 0.53 | 0.64 | 0.63 |
| | | solution 15 | | | | | | | | |
| Example 22 | Side B | Application | Good | PI-33 | 35 | 0.98 | 0.81 | 0.62 | 0.84 | 0.71 |
| | | solution 4 | | | | | | | | |
| Comparative | Side B | Application | Good | PI-29 | 35 | 0.56 | 0.59 | 0.49 | 0.39 | 0.36 |
| Example 6 | | solution 3 | | | | | | | | |

In Table 4,

1) As can be seen from the comparison of Examples 19-22 and Comparative Example 6, the films of Examples 19-22 have higher initial peel strength, and higher peel strengths after heat treatment and after high temperature/high humidity treatment.

2) As can be seen from Examples 19-22, as compared with initial peel strength, the reduction in peel strengths after heat treatment or after high temperature/high humidity treatment is diminished.

3) As can be seen from Examples 19-21 in which different application solvents are employed, the films of Examples 19 and 20 have higher initial peel strength, and higher peel strengths after heat treatment and after high temperature/high humidity treatment than the film of Example 21.

4) As can be seen from Examples 19 and 22 in which the concentrations of the surface treatment agents are different, there seem to be substantially no differences in peel strengths within this range, as compared with the results on adhesive presented in Table 2.

### <Evaluation of Polyimide-Metal Laminate (D) (Wet Plating Method)>

### Examples 23, 24

Polyimide films (PI-34)-(PI-35) were produced in the same way as in Example 18, except that the application solutions shown in Table 5 were used, instead of the application solution (12). And then, polyimide-metal laminates (D) (polyimide film/copper foil) (PI-34)-(PI-35) in which the metals were laminated on the polyimide films by a wet plating method were produced with the polyimide films (PI-34)-(PI-35) in the same way as in the preparation of polyimide-metal laminate (D). The peel strengths of the polyimide-metal laminates (D) (PI-34)-(PI-35) were measured, and the results are shown in Table 5.

TABLE 5

| | | | | | | Peel strength of | | |
|---|---|---|---|---|---|---|---|---|
| | | | | | | polyimide-metal laminate (D) | | |
| | Applied | | Appearance | Polyimide film | | (kN/m) | | |
| | surface of | Application | of film after | | Thickness | | After heat | After heat |
| | film | solution | application | Type | (μm) | Initial | treatment (D1) | treatment (D2) |
| Example 23 | Side B | Application | Good | PI-34 | 35 | 0.56 | 0.80 | 0.75 |
| | | solution 2 | | | | | | |
| Example 24 | Side B | Application | Good | PI-35 | 35 | 0.56 | 0.77 | 0.83 |
| | | solution 4 | | | | | | |

In Table 5,

1) As can be seen from Examples 23 and 24, the films have high initial peel strength and high peel strength after heat treatment.

2) As can be seen from Examples 23 and 24 in which the concentrations of the surface treatment agents are different, there seem to be substantially no differences in peel strengths within this range, as compared with the results on adhesive presented in Table 2. These results are similar to the results presented in Table 4.

3) As can be seen from the comparison of Examples 23, 24 and Examples 19-22 presented in Table 4, the films of Examples 23 and 24 have a little lower initial peel strength, but as high peel strength after heat treatment as the films of Examples 19-22.

### <Contact Angle of Solvent>

The contact angles of the solvents were measured on a polytetrafluoroethylene sheet by a contact angle meter “CA-X” made by Kyowa Interface Science Co., Ltd. The results are shown in Table 6.

### <Boiling Point of Mixture of Solvents>

The mixture of ethylene glycol mono-n-butyl ether and N,N-dimethylacetamide

(DMAc) which contains DMAc in an amount of 5 wt % was distilled at normal pressure, using a simple-distillation device. The initial boiling point was 168° C., and the steady distillation temperature was 170° C. The steady distillation temperature was regarded as the boiling point of the mixture. The results are shown in Table 6.

### <Test of Solubility of Solvent in Water; Water-Solubility Test>

The solvent (solution) shown in Table 6 was gently mixed with an equal volume of pure water and the mixture was allowed to stand still at ordinary temperature and pressure (20° C., 1 atm). The liquid mixture still maintained the appearance of being homogeneous. All of the solvents (solutions) shown in Table 6 were water-soluble liquids.

The surface tension at 30° C. of DMAc is presented in Table 6. The surface tension of a liquid generally increases as the temperature decreases. Accordingly, the surface tension at 20° C. of DMAc is obviously greater than the surface tension at 30° C. (32.4).

### <Rate of Evaporation of Solvent>

The rate of evaporation of the solvent is measured in accordance with ASTM D3539-87. The rate of evaporation is expressed as the time (sec) required for 90 wt % of the solvent (based on the total weight of the solvent charged for measurement) to evaporate. The specific rate of evaporation is expressed relative to n-butyl acetate as the standard solvent.

TABLE 6

| | Surface | Contact | | Rate of evaporation | Specific rate of | |
|---|---|---|---|---|---|---|
| | tension | angle* | Boiling | Time required for | evaporation | |
| | (20° C.) | (23° C.) | point | 90% evaporation | (Index) n- | Water- |
| Solvent | (mN/m) | (°) | (° C.) | (sec)** | butyl acetate = 1 | solubility test |
| ethylene glycol mono-n-butyl ether | 27.3 | 54.1 | 171 | 6780 | 0.07 | homogeneous |
| ethylene glycol monoethyl ether | 27.4 | | 136 | 1190 | 0.39 | homogeneous |
| ethylene glycol mono-n-butyl ether/ | | 54.5 | 170 | | | homogeneous |
| DMAc (DMAc: 5 wt %) | | | | | | |
| diacetone alcohol | 29.8 | 59.1 | 168 | 3840 | 0.12 | homogeneous |
| diethylene glycol monoethyl ether | 31.1 | 60.3 | 217 | | | homogeneous |
| acetate | | | | | | |
| DMAc | 32.4 | 60.7 | 166 | | | homogeneous |
| | (30° C.) | | | | | |
| diethylene glycol monomethyl | 34.8 | | 194 | 26300 | 0.02 | homogeneous |
| ether | | | | | | |
| ethylene glycol | 46.9 | | 197 | | 0.01 | homogeneous |

*Contact angle to polytetrafluoroethylene sheet
**n-butyl acetate: 460 sec.

### <Solvent Resistance Test on Self-Supporting Film>

The polyamic acid solution (A) was cast on a glass plate so that the thickness of the film after curing may be within a range of from 10 μm to 14 μm, to form a thin film. The thin film was heated at a temperature of 138° C. for 30-50 sec, using a hot plate, and then peeled off from the glass plate, to provide a self-supporting film. And then, the solvent shown in Table 7 was applied to the Side B of the self-supporting film, using a bar coater No. 14 (application amount: 29-30 g/m²). Subsequently, while fixing all edges of the self-supporting film with a pin tenter, the film was heated in an oven maintained at 210° C. for 50 sec. The presence or absence of cracks in the film thus obtained was determined, and the results are shown in Table 7.

TABLE 7

| | Solvent resistance of self-supporting film | | | | |
|---|---|---|---|---|---|
| | | Weight loss on | | | Weight loss on |
| | Weight loss on | heating | Weight loss on | Weight loss on | heating |
| | heating | 42 wt % | heating | heating | 39 wt % |
| | 43 wt % | Imidization rate | 41 wt % | 40 wt % | Imidization rate |
| | Imidization rate | A/B | Imidization rate | Imidization rate | A/B |
| Solvent | A/B | 7.3%/7.4% | A/B | A/B | 7.8%/8.9% |
| ethylene glycol mono-n-butyl ether | | | No Crack | | No Crack |
| ethylene glycol mono-n-butyl ether/ | | | No Crack | | |
| DMAc (DMAc: 5 wt %) | | | | | |
| diacetone alcohol | No Crack | | | | |
| diethylene glycol monoethyl ether | | No Crack | | | |
| acetate | | | | | |
| DMAc | | | | Crack | Crack |

### <Repelling/Appearance Test on Self-Supporting Film and Polyimide Film>

### Example 25

The polyamic acid solution (A) was cast on a glass plate, to form a thin film. The thin film was heated at a temperature of 131° C. for 210 sec, using a hot plate, and then peeled off from the glass plate. The self-supporting film thus obtained had a weight loss on heating of 38.0 wt %, a Side A imidization rate of 10.0% and a Side B imidization rate of 18.0%. And then, the application solution (2) was applied to the Side A of the self-supporting film, using a bar coater No. 3 (application amount: 6 g/m²). As a result, the surface treatment agent was not repelled from the surface of the self-supporting film, and the self-supporting film had a good appearance. Subsequently, while fixing all edges of the self-supporting film, to which the application solution is applied, with a pin tenter, the film was heated stepwise in an oven at 100° C. for 240 sec, 140° C. for 86 sec, 200° C. for 86 sec, 370° C. for 86 sec, and then 490° C. for 86 sec to effect imidization, thereby producing a polyimide film having an average thickness of 35 μm. The polyimide film obtained after curing had a good appearance with no repelling marks.

### Example 26

The test was performed in the same way as in Example 25, except that the application solution (8) was used. As a result, the surface treatment agent was not repelled from the surface of the self-supporting film, and the self-supporting film had a good appearance. In addition, the polyimide film obtained after curing had a good appearance with no repelling marks.

### Example 27

The test was performed in the same way as in Example 25, except that the application solution (6) was used. As a result, the surface treatment agent was not repelled from the surface of the self-supporting film, and the self-supporting film had a good appearance. In addition, the polyimide film obtained after curing had a good appearance with no repelling marks.

### Comparative Example 7

The test was performed in the same way as in Example 25, except that the application solution (16) was used. As a result, although the surface treatment agent was not repelled immediately after the surface treatment agent was applied to the self-supporting film, the repelling occurred after 30 sec. In addition, repelling marks appeared in the polyimide film obtained after curing, and the polyimide film was inferior in appearance.

### Comparative Example 8

The test was performed in the same way as in Example 25, except that the application solution (17) was used. As a result, the application solution was repelled from the surface of the self-supporting film when the surface treatment agent was applied to the self-supporting film. In addition, repelling marks appeared in the polyimide film obtained after curing, and the polyimide film was inferior in appearance.

1. A process for producing a polyimide film, comprising:
flow-casting a solution of a polyamic acid, which is prepared by reacting a tetracarboxylic acid component and a diamine component on a support, and drying the solution to form a self-supporting film;
applying a solution containing a surface treatment agent to one side or both sides of the self-supporting film; and
heating the self-supporting film to which the surface treatment agent solution is applied, to provide a polyimide film,
wherein the surface treatment agent solution contains a solvent which is a water-soluble liquid and has a surface tension of 32 mN/m or less at 20° C. and a boiling point of 125° C. or higher.

2. The process for producing a polyimide film as claimed in claim 1, wherein the solvent of the surface treatment agent solution contains at least one selected from the group consisting of ethylene glycol monoethyl ether, ethylene glycol monobutyl ether, diethylene glycol monoethyl ether acetate and diacetone alcohol.

3. The process for producing a polyimide film as claimed in claim 1, wherein the tetracarboxylic acid component comprises 3,3′,4,4′-biphenyltetracarboxylic dianhydride and/or pyromellitic dianhydride as the main component; and the diamine component comprises p-phenylenediamine and/or diaminodiphenyl ether as the main component.

4. The process for producing a polyimide film as claimed in claim 1, wherein the surface treatment agent is a silane coupling agent.

5. The process for producing a polyimide film as claimed in claim 1, wherein the polyimide film is produced by thermal imidization.

6. The process for producing a polyimide film as claimed in claim 1, wherein the self-supporting film has a weight loss on heating of from 20 wt % to 50 wt %.

7. The process for producing a polyimide film as claimed in claim 1, wherein the resulting polyimide film is laminated to a metal layer or an adhesive layer.

8. The process for producing a polyimide film as claimed in claim 1, wherein the resulting polyimide film has a thickness of 20 μm or less.

9. A polyimide film produced by the process as claimed in claim 1.

10. The polyimide-metal laminate comprising a polyimide film as claimed in claim 9, and a metal layer which is formed on the surface of the polyimide film to which the surface treatment agent solution is applied during production.

11. The polyimide-metal laminate as claimed in claim 10, wherein the metal layer is formed by a metallizing method or a wet plating method.

12. A polyimide laminate comprising a polyimide film as claimed in claim 9, and an adhesive layer which is formed on the surface of the polyimide film to which the surface treatment agent solution is applied during production.

13. A polyimide-metal laminate comprising a polyimide laminate as claimed in claim 12, and a metal foil which is bonded onto the adhesive layer of the polyimide laminate.
